(19) United States
(12) Patent Application Publication
(10) Pub. No.: US 2008/0136905 A1
(43) Pub. Date: Jun. 12, 2008

(54) Position detecting apparatus

(75) Inventors: Shigenori Shibue, Tokyo (JP); Yoshinori Asamura, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 11/889,314

(22) Filed: Aug. 10, 2007

(30) Foreign Application Priority Data
Dec. 12, 2006 (JP) 2006-334561

(51) Int. Cl. H04N 9/44

(52) U.S. Cl. 348/94

(57) ABSTRACT

A position detecting apparatus includes an indicating unit 2 for projecting light onto the front surface of a display screen 11 on which imaging light is projected from the back thereof by a projector 12, an imaging unit 3 placed at the back of the display screen 11, for picking up from the back thereof the light projected by the indicating unit 2 and for converting the light into electric signals, and an image processing unit 4 for analyzing the electric signals obtained from the imaging unit 3 and for calculating a position on the display screen 11, of the indicating unit 2.

### BACKGROUND OF THE INVENTION

1. Field of the Invention

The present invention relates to position detecting apparatus that optically detects a position on a display screen, indicated by an indicating unit.

2. Description of the Related Art

As for an apparatus that optically detects an indicated position on a display screen, a position detecting apparatus has been proposed (in Patent Document 1, for example); the apparatus is provided at the front circumference of a display screen with a light source and a retroreflective material, and detects a position that an indicating unit indicates, by emitting a scanning beam parallel to the display screen and taking an image produced by retroreflective light from the indicating unit placed on the display screen.

Patent Document 1: Japanese Patent Laid-Open No. 2004-5171 (paragraph 0016, and FIG. 1)

In an above-mentioned method in which an image of the indicating unit is taken at the front of the display screen, a problem has been that when an obstacle is placed on the screen the apparatus can not distinguish the indicating unit from the obstacle, so that the apparatus can not detect accurately the position of the indicating unit.

The present invention is made to solve the problem above-mentioned, and aims to obtain a position detecting apparatus that can detect accurately a position on a display screen, indicated by an indicating unit.

### SUMMARY OF THE INVENTION

A position detecting apparatus according to the present invention includes an indicating unit for projecting light onto the front surface of a display screen on which imaging light is projected from the back thereof by a projector, an imaging unit placed at the back of the display screen, for picking up from the back thereof the light projected by the indicating unit and for converting the light into an electric signal, and an image processing unit for analyzing the electric signal obtained from the imaging unit and for calculating a coordinate position on the display screen, of the indicating unit.

According to the present invention, a position detecting apparatus detects a position of light projected by an indicating unit onto the front of a display screen by taking from the back of the screen an image thereof; therefore, even with an obstacle placed on the display screen, the apparatus can detect accurately a position on the display screen, of the indicating unit.

### BRIEF DESCRIPTION OF THE DRAWINGS

FIG. 1 is a configurational view of a position detecting apparatus of Embodiment 1 according to the present invention;

FIG. 2 is a configurational view of an indicating unit of Embodiment 1 according to the present invention;

FIG. 3 is a view for explaining the operations of the position detecting apparatus of Embodiment 1 according to the present invention; and

FIG. 4A, FIG. 4B, FIG. 4C, FIG. 4D, FIG. 4E, and FIG. 4F are views of electric signals that an imaging unit, of Embodiment 1 according to the present invention, outputs.

### DETAILED DESCRIPTION OF THE PREFERRED EMBODIMENTS

### Embodiment 1

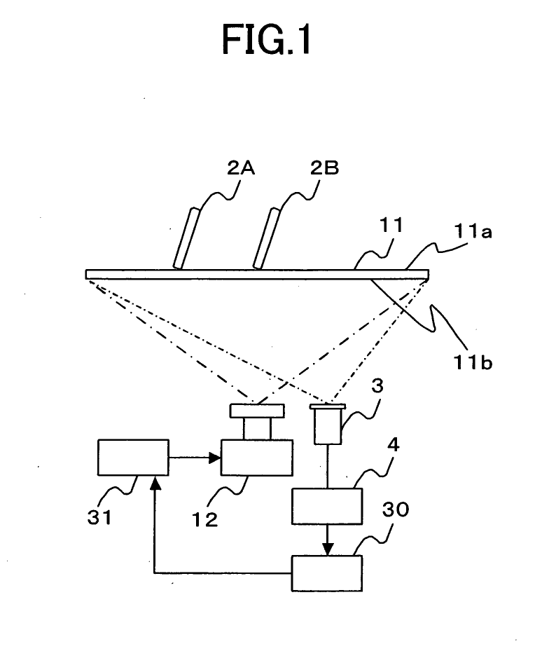

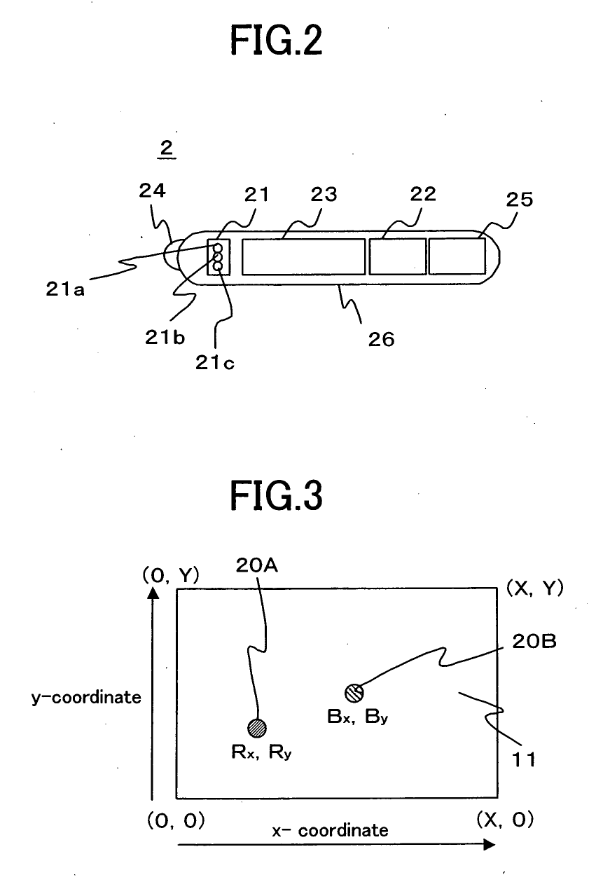

In FIG. 1 and FIG. 2, a position detecting apparatus of Embodiment 1 according to the present invention is illustrated. FIG. 1 is a configurational view of the position detecting apparatus, and FIG. 2 is a configurational one of an indicating unit of the position detecting apparatus. The position detecting apparatus shown in the figures includes indicating units 2A and 2B (for convenience, each of them is simply referred to as “2”) that project light of a predetermined wavelength, an imaging unit 3 for picking up images of a displaying surface 11a of a display screen 11 (a display screen of a rear projector) from the back-face 11b side, and an image processing unit 4 for analyzing electric signals obtained from the imaging unit 3 and for calculating two-dimensional coordinates on the display screen 11, of the light projected from the indicating units 2A, 2B, or 2.

When the front surface 11a of the display screen 11 is touched with the tip of the indicating unit 2, the unit projects light of a predetermined wavelength onto the display screen 11. As the configuration of the indicating unit shown in FIG. 2, a light-emitting portion 21 including a plurality of light-emitting diodes each having a different wavelength, a switch 22 for selecting a wavelength of light to be projected (a light-emitting diode), a driver 23 for driving the selected light-emitting diode, a lens 24 provided at the tip thereof for outputting efficiently light from the light-emitting portion 21, and a power source 25 are provided in a housing 26. The light-emitting portion 21 is provided with three types of light-emitting diodes 21a, 21b, and 21c each of which has a different wavelength. The light-emitting diode 21a emits red light (660 nanometers); the light-emitting diode 21b emits blue green light (560 nanometers); the light-emitting diode 21c emits purple light (420 nanometers). These wavelengths are selected from wavelengths excluding a line spectrum (440 nanometers, 550 nanometers, and 580 nanometers) of light from a light-emitting lamp that is a light source of the projector 12 and not shown in the figure; that is, the wavelengths are selected from wavebands that the projector 12 projects with low intensities or hardly projects as a matter of practice. When switching with the selection switch 22 from one of the light-emitting diodes to a different one to emit light, the indicating unit 2 can change its wavelength of light to emit light. In this embodiment, using two indicating units 2A and 2B, the light-emitting diode 21a of the indicating unit 2A is selected to emit red light (660 nanometers) and the light-emitting diode 21b of the indicating unit 2B is selected to emit blue green light (500 nanometers), so that the wavelengths of the light projected by the indicating units 2A and 2B are different from each other. In addition, in this embodiment, it has been exemplified that the two indicating units 2A and 2B are used as indicating units; one indicating unit 2, or three or more indicating units 2 may be used.

The imaging unit 3 is housed in the rear projector housing not shown in the figure so that a camera (a main component of the imaging unit 3) is installed close to the projector 12 of the rear projector, as shown in FIG. 1. More specifically, the imaging unit 3 is placed in such a manner that the front faces of the projector 12 and the camera of the imaging unit 3 are each aligned on a plane approximately parallel to the display screen 11. This enables the imaging area of the imaging unit 3 to include an area on the display screen 11 onto which the projector 12 projects images, and prevents the imaging unit 3 from blocking an optical path through which the projector 12 projects images onto the display screen 11. In addition, the imaging unit 3 is provided with optical filters not shown in the figure in order to distinguish light in wavelength, so that the imaging unit converts into electric signals the light of the wavelengths (660 nanometers, 500 nanometers, and 420 nanometers) that the indicating unit 2 can project, distinguishing the wavelengths.

On the basis of the electric signals that have been outputted from the imaging unit 3 separately in wavelengths, the image processing unit 4 separately calculates the positions of the indicating units 2A and 2B as the two-dimensional coordinates on the display screen 11. The two-dimensional-coordinate positional information calculated for each of the indicating units 2A and 2B is inputted into a computer 31 through an external interface 30 such as a local-area network (LAN) or a universal serial bus (USB).

The computer 31 stores image information and outputs the stored information to the projector 12 as image signals. At this time, if the positional information is inputted from the external interface 30, application software having been installed in the computer controls the image information on the basis of the inputted positional information, and outputs as image signals the controlled image information to the projector 12.

The projector 12 receives the image signals and projects the image from the back of the display screen 11 so that the projected image forms an image on the front-most surface 11a of the display screen 11; therefore, the image that is produced from the image signals outputted by the computer 31 can be seen from the front side of the display screen 11.

The operations of this apparatus are described below.

When the displaying surface 11a is touched simultaneously with the two indicating units 2A and 2B, a light spot 20A due to the light of the 660-nanometer wavelength projected by the indicating unit 2A and a light spot 20B due to the light of the 500-nanometer wavelength projected by the indicating unit 2B, appear on the back surface 11b of the display screen 11. At the same time, on the back surface 11b of the display 11, the projector 12 also produces images. However, the imaging unit 3 distinguishes light in wavelength, so that the imaging unit only detects as images, as shown in FIG. 3, images of the light spots 20A and 20B. In addition, the imaging unit outputs different signals while distinguishing between the light from the spot 20A having been projected by the indicating unit 2A and the light from the spot 20B having been projected by the indicating unit 2B. Even when there is an obstacle on the display screen 11, because the imaging unit 3 only detects the light from the spots 20A and 20B that has been projected by the indicating units 2A and 2B, the imaging unit 3 does not detect erroneously the obstacle.

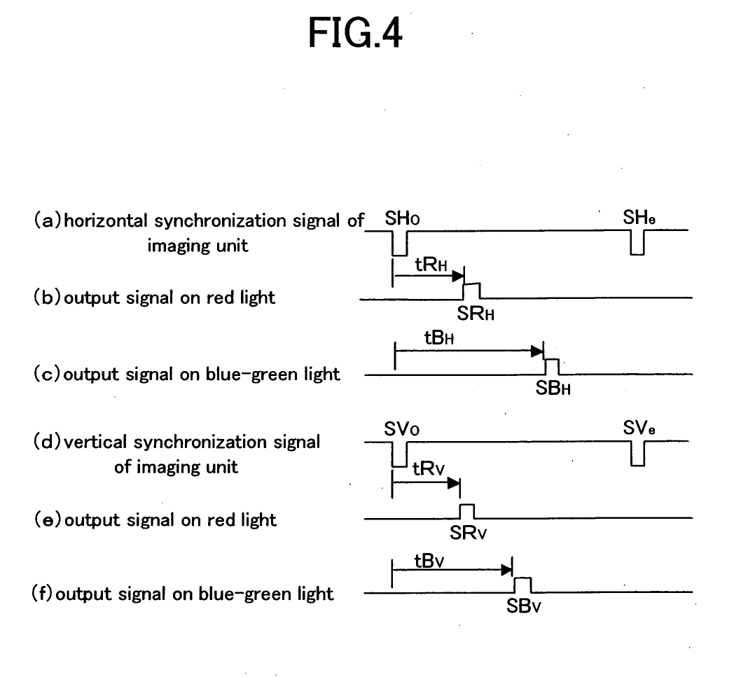

The image processing unit 4 separates electric signals SR corresponding to the light from the spot 20A and electric signals SB corresponding to the light from the spot 20B from signals outputted by the imaging unit 3, and the imaging processing unit calculates separately the coordinate positions on the display screen 11 that have been indicated by the indicating units 2A and 2B. Using FIG. 4, coordinate calculations will be exemplified below. In the figures, FIG. 4A illustrates a horizontal synchronization signal, FIG. 4B illustrates a signal for detecting the red light from the spot 20A projected by the indicating unit 2A, and FIG. 4C illustrates a signal for detecting the blue green light from the spot 20B projected by the indicating unit 2B. In FIG. 4A, the starting point SHₒ of the horizontal synchronization signal corresponds to the left extremity (x=0) in the horizontal direction on the display screen 11, and the ending point SHₑ thereof corresponds to the right extremity (x=X) in the horizontal direction on the display screen 11. That is, using a time tR_{H} between the staring point SHₒ and a time point SR_{H} at which an electric signal due to the red light from the spot 20A is detected, the horizontal position of the light spot 20A (Rₓ) on the display screen can be calculated. In a similar fashion, the horizontal position Bₓ of the blue green light spot 20B can be calculated, using a time tB_{H} between the time SHₒ and a time point SB_{H} at which the light signal is detected.

Similar calculations are made for vertical coordinates as follows. In FIG. 4D, the starting point SVₒ of the vertical synchronization signal corresponds to the bottom extremity (y=0) in the vertical direction on the display screen 11, an ending point SVₑ thereof corresponds to the top extremity (y=Y) in the vertical direction on the display screen 11; FIG. 4E illustrates a signal when detecting the red light from the spot 20A projected by the indicating unit 2A; and FIG. 4F illustrates a signal when detecting the blue green light from the spot 20B projected by the indicating unit 2B. That is, using a time tR_{V} between the staring point SVₒ and a time point SRᵥ at which an electric signal due to the red light from the spot 20A is detected, the vertical position of the light spot 20A (R_{y}) on the display screen can be calculated. The vertical position B_{y} of the blue green light spot 20B can also be calculated, using a time tBᵥ that is between the time SVₒ and a time point SBᵥ at which the light signal is detected.

The two-dimensional-coordinate positional information calculated for each of the indicating units 2A and 2B is inputted from the image processing unit 4 into the computer 31 through the external interface 30 such as the LAN or the USB; the computer 31 controls images stored therein on the basis of the inputted positional information. Then, images that have been controlled on the basis of the positional information are displayed in real-time onto the display screen 11 of the rear projector.

According to the embodiment described above, because an imaging unit 3 takes from the back of a display screen 11 an image of light that an indicating unit 2 has projected onto the front of the display screen in order to detect the position of the indicating unit 2, even with an obstacle placed on the display screen 11, an apparatus can accurately detect the indicated positions on the display screen 11, indicated by one or more indicating units 2. In addition, because the imaging unit 3 is placed in a manner that the front faces of a camera of the imaging unit and a projector 12 are each aligned on a plane approximately parallel to the display screen 11, the imaging unit 3 can be prevented from blocking an optical path through which the projector 12 projects images onto the display screen 11, and the quality of the images projected onto the display screen 11 can be prevented from degrading.

Furthermore, because the imaging unit 3 is configured to take images, distinguishing the light of the predetermined wavelengths projected by the indicating units 2, and to convert the light into electric signals corresponding to its wavelengths, the apparatus can distinguish the light projected by one or more indicating units 2 from other light and can accurately detect each position of the indicting units 2 without erroneously detecting outside light and such. In particular, because a wavelength of light to be projected by the indicating unit 2 can be selected among a plurality of wavelengths, erroneous operations that could be caused by erroneous detections of outside light are easily prevented by appropriately changing the wavelengths in use.

The wavelengths of the light to be projected by the indicating units 2 are selected from wavelengths different from line spectrums of a light source of the projector 12; therefore, the images on the display screen 11 projected by the projector are not confused with the light on the display screen 11 projected by the one or more indicating units 2, and the apparatus does not erroneously detect the positions of the indicating units 2. In addition, the wavelength of the light-emitting member 21 in the indicating unit 2 may be selected among a nonvisible light band such as infrared light. In this case, the imaging unit 3 is required to distinguish the infrared light to be detected. In addition, even when the wavelength of light projected by the indicating unit 2 coincides with one of those included in outside light or images projected from the projector, provided that the intensity of the light projected by the indicating unit is set higher than those of the outside light and of the images projected from the projector, the apparatus can detect the position of the indicting unit 2, distinguishing the light projected by the indicating unit 2 from the outside light and from the images projected by the projector.

Furthermore, the imaging unit 3 is configured so as to distinguish from each other the light with the different wavelengths that is projected by the plurality of the indicating units (the indicating units 2A and 2B) and to convert separately the light into electric signals; therefore, even when the plurality of the indicating units (the indicating units 2A and 2B) is used simultaneously to indicate positions on the display screen 11, each of the indicated positions can be detected independently. According to this embodiment, the indicating unit 2 is configured such that one of the three types of light each having a different wavelength can be selected to be projected; even when three indicating units (the indicating units 2A, 2B, and 2C) are used simultaneously, provided that the switches 22 of the indication units are set so that the wavelengths of the light to be projected by the units are different from each other, the positions indicated by the three indicating units 2A, 2B, and 2C can be calculated simultaneously and independently. Furthermore, without confining to the present embodiment, if the number of wavelengths that the imaging unit 3 can distinguish is increased and the number of wavelengths of light projected from the respective indicating units 2 is increased, it is possible to increase the number of the indicating units 2 that can be simultaneously used.

In the embodiment, the positions of the indicating units 2A and 2B are detected as the two-dimensional coordinates on the display screen 11; however, the positions may be detected as one-dimensional coordinates on either an x-axis or a y-axis.

In addition, in order to save electricity of the power source 25, the indicating unit 2 may be configured to have a push switch that energizes the unit only when the display screen 11 is touched by the indicating unit 2.

Furthermore, when an indicating unit 2 is configured to have a light source with light-condensing characteristics such as laser light so that the unit can spot-emits the light on the display screen 11 from some distance, it becomes possible to indicate a position without touching the display screen 11 with the indicating unit 2.

What is claimed is:

1. A position detecting apparatus, comprising:
one or more indicating units for projecting light onto the front surface of a display screen on which imaging light is projected from the back thereof by a projector;
an imaging unit placed at the back of the display screen, for picking up from the back thereof the light projected by the indicating units and for converting the light into electric signals; and
an image processing unit for analyzing the electric signals obtained from the imaging unit and for calculating a position on the display screen, of the indicating units.

2. A position detecting apparatus according to claim 1, wherein the imaging unit is placed in a manner that the front faces of the imaging unit and the projector are each aligned on a plane approximately parallel to the display screen.

3. A position detecting apparatus according to claim 1, wherein the imaging unit distinguishes light of predetermined wavelengths that has been projected by the one or more indicating units, and converts the light into electric signals.

4. A position detecting apparatus according to claim 1, wherein the imaging unit distinguishes from each other light of predetermined different wavelengths that has been projected by a plurality of the indicating units, and converts the light into electric signals.

5. A position detecting apparatus according to claim 3, wherein the predetermined wavelengths are selected from wavelengths different from line spectrums of a light source of the projector.

6. A position detecting apparatus according to claim 4, wherein the predetermined wavelengths are selected from wavelengths different from line spectrums of a light source of the projector.
